(19) United States
(12) Patent Application Publication
(10) Pub. No.: US 2023/0350031 A1
(43) Pub. Date: Nov. 2, 2023

(54) LIDAR DEVICE WITH IMPROVED DYNAMIC RANGE

(71) Applicant: Robert Bosch GmbH, Stuttgart (DE)

(72) Inventors: Annette Frederiksen, Renningen (DE); Mustafa Kamil, Ludwigsburg (DE)

(21) Appl. No.: 18/064,515

(22) Filed: Dec. 12, 2022

(30) Foreign Application Priority Data
Dec. 15, 2021 (DE) 102021214433.0

(51) Int. Cl. G01S 7/481; G01S 7/486

(52) U.S. Cl. CPC G01S 7/4868; G01S 7/4814; G01S 7/4816; G01S 7/4817

(57) ABSTRACT

A LIDAR device for scanning scanning areas. The LIDAR device includes an emitting unit that includes at least one beam source for generating and for emitting beams into the scanning area, and includes a receiving unit that includes at least one detector for receiving beams backscattered and/or reflected from the scanning area, a radiant power of the beams backscattered and/or reflected from the scanning area directed at the at least one detector in the area of the emitting unit and/or in the area of the receiving unit being actively and/or passively dampable for expanding the dynamic range.

### FIELD

The present invention relates to a LIDAR device for scanning scanning areas, including an emitting unit that includes at least one beam source for generating and for emitting beams into the scanning area, and including a receiving unit that includes at least one detector for receiving beams backscattered and/or reflected from the scanning area.

### BACKGROUND INFORMATION

LIDAR systems may be versatilely designed and are used in different fields, such as in the implementation of automated driving functions. LIDAR systems are available, for example, in the form of rotating macro-scanners, micro-scanners or flash systems. Of these, rotating or scanning LIDAR systems, in particular, including at least one flashed sub-area such as, for example, a line flash, are preferably used.

The problem with today’s LIDAR systems is the dynamic range in the case of objects that reflect to different degrees at different distances. In this case, a LIDAR system must be able to reliably distinguish objects having a particularly low reflectivity (for example, 5%) at a great distance (for example, 140 m) as well as retroreflectors having a particularly high reflectivity (for example, 10000%) at a short distance (for example, 1.5 m). The resulting dynamic factor between the darkest and the brightest object to be recognized is 2000 at the same distance. In addition, the portion of the signal intensity scaling quadratically with the distance must be taken into account. In the design of a LIDAR system for the detection of objects having low reflectivity, in particular, stronger reflecting objects such as, for example, retroreflectors in the form of street signs, taillights and the like, result in a cross-talk of the detector or in so-called crosstalk effects. In the resulting 3D point cloud, for example, a continuous wall is visible below and above the strongly reflecting objects which, however, in reality does not exist.

### SUMMARY

An object underlying the present invention is to provide a LIDAR device with an improved or expanded dynamic range.

This object may be achieved with the aid of features of the present invention. Advantageous embodiments of the present invention are disclosed herein.

According to one aspect of the present invention, a LIDAR device is provided for scanning scanning areas. The LIDAR device includes an emitting unit including at last one beam source for generating and for emitting beams into the scanning area.

In addition, according to an example embodiment of the present invention, the LIDAR device includes a receiving unit including at least one detector for receiving beams backscattered and/or reflected from the scanning area. According to the present invention, a radiant power of the beam backscattered and/or reflected from the scanning area directed at the at least one detector is actively and/or passively dampable in the area of the emitting unit and/or in the area of the receiving unit. By damping the radiant power, a dynamic range of the LIDAR device is expanded or enlarged, in particular, in the case of high reflected radiant powers.

According to one further aspect of the present invention, a method is provided for scanning scanning areas using a LIDAR device. According to an example embodiment of the present invention, in one step, beams in pulsed form are generated by at least one beam source and emitted into the scanning area. Beams reflected and/or backscattered from the scanning area are received by at least one detector. The scanning area is preferably scanned by beams having a damped radiant power and/or by beams having an undamped radiant power in order to expand a dynamic range of the LIDAR device.

As a result of the possibility of restricting the radiant power or radiant intensity of the beams from the scanning area striking the detector, it is possible to reliably operate the LIDAR device under conditions that would normally lead to crosstalk effects. Thus the LIDAR device is able to also scan highly reflective objects without a crosstalk of the detector.

Crosstalk effects are caused by a saturation of the detector, since the latter is also designed for recognizing very dark objects. If highly reflecting objects are illuminated by the emission path, this results in a strong reflection of the optical power in the detection path. This radiant power results in a crosstalk between detector pixels due to scattering and multiple reflections in the receiving path, the resulting photons resulting in erroneous detections in the wrong solid angle along detector columns and/or detector rows. In the generated measured data in the form of a 3D point cloud, a continuous wall, for example, is then visible below and above the highly reflecting object which, however, in reality does not exist. When evaluating the raw signals of the detector, a recognition of the signal intensity is also no longer possible, since the pulse shape is truncated from above due to the detector saturation. The only conclusion possible is that it involves a particularly highly reflecting object.

The detector of the LIDAR device in the undamped state is able to also optimally detect dark objects or poorly reflecting objects. In the case of highly reflecting objects, which would regularly result in crosstalk, a switch takes place in the form of an increased damping of the incoming and/or emitted radiant power. Thus, the simultaneous detection of poorly reflecting and highly reflecting objects by the LIDAR device is possible.

In addition to the reduction of optical crosstalk effects, a minimization of erroneous detections may also be achieved. Different systems that utilize the measured data of the LIDAR device may benefit therefrom. For example, brake misapplications in automated driving functions may be prevented due to the increased reliability of the LIDAR device. The LIDAR device in this case is versatilely implementable, since the damping of the radiant power is implementable based on different measures in the area of the emitting unit and/or the receiving unit.

In addition, the LIDAR device may enable an adaptive adaptation of the damping or illumination intensity to the surroundings for an increased dynamic range. According to an example embodiment of the present invention, the LIDAR device in this case may be implemented as a reconstruction or redevelopment or in the form of a retrofit solution in existing LIDAR systems. As a result, the LIDAR device according to one aspect of the present invention may be designed as a retrofit, which is configured to be integrated into an existing LIDAR system in order to carry out a dynamic and situational adaptation of the radiant power of the beams incoming at the at least one detector.

According to one embodiment of the present invention, the beams with dampened radiant power are generated by at least one beam source with reduced power. Alternatively or in addition, the beams reflected and/or backscattered from the scanning area are damped with respect to the radiant power by active or passive damping elements to form beams with damped radiant power. An active adjustment of the radiant power or of the damping is implemented as a result.

According to one further embodiment of the present invention, the beams with the damped radiant power and the beams with the undamped radiant power are generated and received in temporal succession. Alternatively or in addition, the beams with the damped radiant power and the beams with the undamped radiant power are emitted into the scanning area and received from the scanning area spatially separated from one another. In this way, a separation of the damped and undamped beams may be implemented, so that the resulting reflections are received by different detectors or at different sections of a detector surface. In a subsequent step, the respective signals may be joined and the dynamic range may be maximized.

In one exemplary embodiment of the present invention, the LIDAR device includes at least one first detector and at least one second detector. The first and the second detector may be independent detectors or detector units or sections of a detection surface of a single detector.

According to one further specific embodiment of the present invention, only measured data of the first detector or only measured data of the second detector or measured data of the first detector and of the second detector combined with one another are situationally receivable for a further processing by a control unit. In particular, an adaptive switch of the detectors used or of the measured data generated, for example, by the control unit, may take place. In this way, measured data may be selected in such a way that a crosstalk of a detector is avoided. A corresponding switch between the detectors may take place within the scope of a data evaluation in the area of a software or at the hardware level via one or multiple switch elements.

As a result of the combination of the measured data of the first detector and of the second detector, it is possible to increase the detection probability via a double scanning of the scanning area. Moreover, the correlation between the two independent single detector noises of the measured data of the first and of the second detector allows for a reduction of the noise level in both detectors. For this purpose, the correlation between the two independent single detector noises is used for calibration or as a noise offset of the detectors in order to reduce the background noise.

According to one further exemplary embodiment of the present invention, the LIDAR device includes at least one first detector and at least one second detector, the radiant power directed at the first detector of the beams backscattered and/or reflected from the scanning area being passively and/or actively damped. As a result, different measures may be taken in order to prevent a local saturation of at least one detector and a resulting crosstalk.

According to one further specific embodiment of the present invention, at least one filter is situated in the receiving unit upstream from the first detector and/or at least one filter is situated downstream from the at least one beam source in the emitting unit for passive damping of the radiant power. The filter may preferably be designed as an ND filter or gray filter in order to lower the emitted radiant power of the beams emitted through the filter. A filter of this type may be situated in an arbitrary position in the emission path and/or in the receiving path of the LIDAR device and has the advantage that no regulations of any kind are required for the operation. Moreover, no additional power is required.

According to one further exemplary embodiment of the present invention, at least one LCD array upstream from the first detector is situated in the receiving unit for active damping of the radiant power. With this measure, a precise control of the beams directed at the first detector may take place. Depending on the design, the LCD array may be made up of multiple switchable pixels or elements, which darken transparently or gradually, for example, which may be adjusted by a control unit.

The control unit in this case may assume the active damping of the radiant power in the emission path and/or in the receiving path of the LIDAR device. Moreover, the control unit may be connected in a data-conducting manner to at least one detector in order to receive and evaluate the generated measured data of the detector. For this purpose, the measured data may be stored at least temporarily in a memory. The memory may be situated outside the control unit or may be integrated in the control unit.

Within the scope of the evaluation of the measured data, the control unit may, in particular, register a crosstalk of at least one detector and initiate a corresponding damping of the radiant power.

Alternatively or in addition, the damping may be implemented by switching a used beam source and/or by switching a used detector and/or by regulating an active damping member such as, for example, an LCD array.

According to one specific embodiment of the present invention, the LCD array is activatable pixelwise by the control unit in order to damp an entire detection surface or at least a section of the detection surface of the first detector with respect to the incoming radiant power. In this way, it is possible to locally hide or dim target areas that cause a crosstalk of the detector, thereby enabling a particularly precise control of the active damping of the radiant power in the form of a planar damping distribution.

According to one exemplary embodiment of the present invention, a damping of the radiant power is adjustable or changeable by the LCD array during a dark phase of the LIDAR device. In this way, operating pauses of the LIDAR device may be utilized to switch or to adjust the LCD array with respect to its optical transmission or damping properties.

According to one further specific embodiment of the present invention, the backscattered and/or reflected beams directed at the at least one detector is indirectly actively dampable by at least one power-regulated beam source.

The control unit is preferably able to activate or regulate the power-regulated beam source in such a way that the generated beams are adjusted or changed with respect to their radiant power. With this measure, it is possible to implement an adaptive and situationally adapted readjustment of the beam source.

According to one further exemplary embodiment of the present invention, the control unit decreases the radiant power of the power-regulated beam source in the case of a crosstalk of the detector ascertained based on received measured data of at least one detector. The radiant power of the beam source may thus be graded after an ascertained crosstalk of the detector in order to prevent the crosstalk effect or to mitigate corresponding effects. After a predefined time span, the power of the beam source may be raised directly or gradually to an original level.

According to one further specific embodiment of the present invention, the LIDAR device includes one first beam source and one second beam source, the second beam source generating beams having a lower radiant power compared to the generated beams of the first beam source. In this case, a more powerful first beam source and a less powerful second beam source may be used in order to optionally revert to a damping based on a weaker illumination of the scanning area using the second beam source.

According to one further exemplary embodiment of the present invention, the beams generated by the first beam source are guidable as backscattered and/or reflected beams from the scanning area to the second detector, and the beams generated by the second beam source are guidable as backscattered and/or reflected beams from the scanning area to the first detector. As a result of this measure, the first detector is illuminated in principle with the beams of the less powerful second beam source. The second detector is illuminated with the beams of the more powerful beam source. This may take place simultaneously or as needed. The control unit may, in particular, adaptively select the measured data of the first detector and/or of the second detector for the further processing. Alternatively or in addition, the control unit may activate the first beam source and/or the second beam source in order to enable a stronger or weaker scanning of the scanning area.

For a particularly powerful illumination of the scanning area, for example, for a temporary increase in the range, the generated beams of all beam sources may be merged and emitted into the scanning area. This may take place, for example, via a semi-transparent mirror.

The scanning area may be scanned with the aid of rotatable or pivotable deflection units or scanned by a rotatable or pivotable LIDAR device in the form of a flash LIDAR. The concept of the LIDAR device is thus not limited to a particular design.

According to one further specific embodiment of the present invention, the first beam source and the second beam source are situated at an angle next to one another in order to illuminate different detectors. With this measure, it is possible to achieve a technically simple implementation of a spatial separation between less powerful and more powerful beams. In this case, the respective beam sources may optionally be individually activated or both simultaneously activated.

According to one further exemplary embodiment of the present invention, the beams generated by the first beam source are guidable to the first detector and to the second detector as backscattered and/or reflected beams from the scanning area.

Alternatively or in addition, the beams generated by the second beam source are guidable to the first detector and to the second detector as backscattered and/or reflected beams from the scanning area.

The scanning area may thus optionally be scanned with generated beams of the first beam source, of the second beam source or with generated beams of both beam sources. The detectors in this case may be simultaneously activated. Alternatively or in addition, a selective connection of detectors by the control unit may also take place in the case of a spatial separation of the generated beams. In this case, the first beam source or the second beam source is also adaptively activatable or selectable by the control unit.

In addition to the targeted activation of the beam sources, a connection of the beam sources may also be implemented in the form of a switchable or moveable aperture, which is movable by control commands of the control unit.

According to one further specific embodiment of the present invention, the generated beams of the first beam source are emittable into the scanning area via a deflection mirror and through a semi-transparent mirror, the generated beams of the second beam source being emittable into the scanning area via the semi-transparent mirror. As a result of this measure, it is possible via the control unit to individually connect and to operate simultaneously, if needed, the beam sources in order to achieve an additional increase in the radiant power, since during an operation of all beam sources, the generated beams are merged by the semi-transparent mirror prior to being emitted into the scanning area.

According to one further exemplary embodiment of the present invention, the semi-transparent mirror is designed as a polarizing, semi-transparent mirror or as a dichroic mirror. When using a dichroic mirror, the first beam source emits generated beams, which have a wavelength differing from the generated beams of the second beam source. Thus, differences in the wavelength of the generated beams may be used for a separation of the generated beams with varying power.

### BRIEF DESCRIPTION OF THE DRAWINGS

Preferred exemplary embodiments of the present invention are explained in greater detail below with reference to highly simplified schematic representations.

FIG. 1 shows a receiving unit of a LIDAR device according to the present invention according to one specific embodiment.

FIG. 2 shows detail views of an arrangement made up of a first detector and an LCD array upstream therefrom, according to an example embodiment of the present invention.

FIG. 3 shows a top view of an emitting unit including two beam sources with varying radiant powers, according to an example embodiment of the present invention.

FIG. 4 shows a representation of the LIDAR device including an emitting unit from FIG. 3, according to an example embodiment of the present invention.

FIG. 5 schematically shows a top view onto a LIDAR device according to one further exemplary embodiment of the present invention.

### DETAILED DESCRIPTION OF EXAMPLE EMBODIMENTS

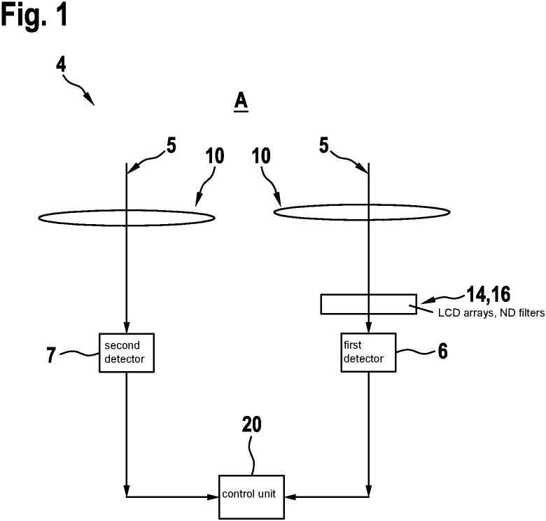

A receiving unit 4 of a LIDAR device 1 according to the present invention is represented in FIG. 1. In this representation, beams 5 backscattered and/or reflected from a scanning area A are received by receiving unit 4. In the exemplary embodiment represented, a damping of a radiant power of beams 5 backscattered and/or reflected from the scanning area takes place in the area of receiving unit 4. The damping in this case may be implemented in principle both in the emitting unit, receiving unit as well as in the emission path and receiving path.

Receiving unit 4 includes, for example, one first detector 6 and one second detector 7, which form a receiving path. In the case of so-called vertical-line flash systems, these detectors 6, 7 are made up of two directly adjacent detector columns including respective optics.

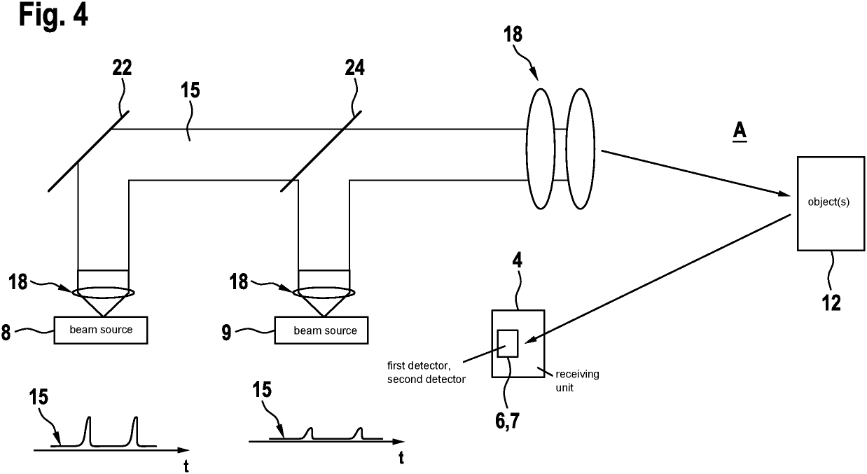

In combination with a simple emission path shown, for example, in FIG. 4, the optical mapping of the surroundings is slightly blurred, so that both detectors 6, 7 scan the same solid angle. In the case of emitting unit 2 including the simple emission path, generated beams 15 from multiple beam sources 8, 9 are combined to form a resulting beam, which is emitted into scanning area A.

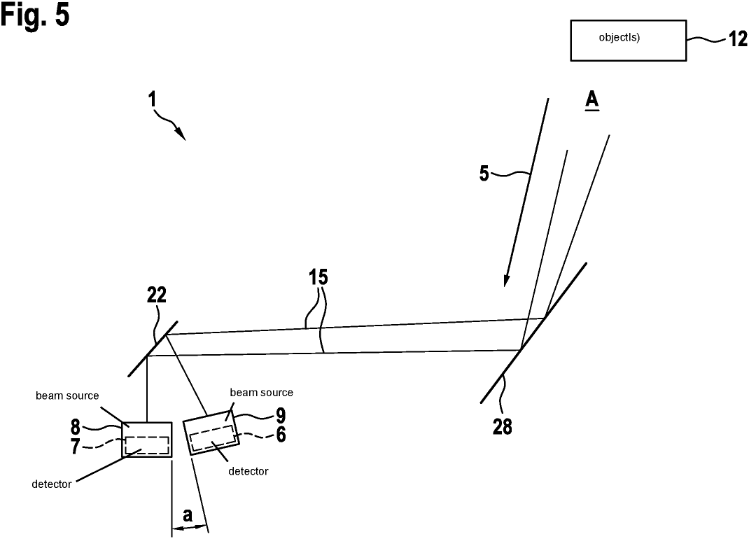

In combination with a doubly implemented emission path of emitting unit 2 shown, for example, in FIG. 5, receiving optics not shown map the surroundings or scanning area A clearly onto detectors 6, 7 and a separation of beam sources 8, 9 relative to one another takes place via different angles a on the emitting side.

Second detector 7 is either undamped or only slightly damped and is thus optimized for scanning poorly reflective objects 12. First detector 6 exhibits a stronger damping for scanning highly reflective objects 12. The damping in the exemplary embodiment represented may be carried out with filters 16 designed as passive ND filters. Alternatively, active LCD arrays 14 may also be used.

Passive ND filters 16 have the advantage that they consume no energy. LCD arrays 14 have the advantage of adaptive adaptation and, in addition, may be connected in a pixelwise manner.

In the configuration of damping elements 14, 16 according to the present invention, particularly advantageous signal levels result, which allow for an increased dynamic range of LIDAR device 1. In the case of poorly reflective objects 12, first detector 6 is in the noise range, and in the case of highly reflective objects 12, in an optimal signal range. Combined, both detectors 6, 7 show a significantly larger dynamic range than a single detector, both at the signal level as well as in the point cloud. In the case of non-existing or weak damping in poorly reflective objects, second detector 7 is in an optimal signal range, and in the case of highly reflective objects 12 in saturation. The measured data generated by detectors 6, 7 are received and evaluated by a control unit 20.

Combined at the signal level, a further interesting advantage also results. If the noise sources of the respective detector are predominantly white noise, then the correlation between the independent noise sources results according to signal theory in a significantly reduced overall noise than that of the individual sources.

A significant advantage of receiving unit 4 represented is also the reduction of optical crosstalk. Since highly reflective objects 12 are scanned with strongly damped detector 6, these objects 12 appear in the form of “darker” measured data than in the undamped or in a weakly damped second detector 7.

Significantly fewer photons are available for triggering saturation effects and scattered light in the detection path.

The positioning of damping elements 14, 16 may take place at an arbitrary position of the receiving unit in the receiving path of detectors 6, 7.

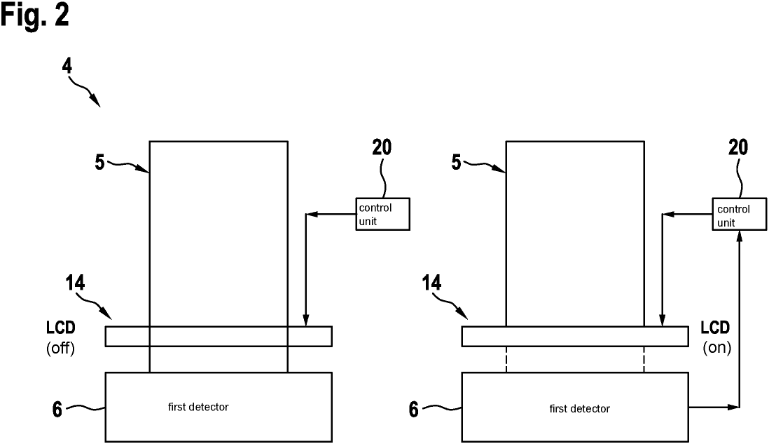

FIG. 2 illustrates in a detailed view the damping of the radiant power of beams 5 by an LCD array 14. In this view, an arrangement including a detector 6 and an upstream LCD array 14 in a transparently connected state is illustrated to the left and, to the right, an arrangement including first detector 6 and an upstream LCD array 14 in a damped connected state. A degree of damping or degree of dimming of LCD array 14 may be adjusted by control unit 20.

In this case, control unit 20 may adjust the damping degree of LCD array 14 as a function of the received measured data of detector 6. Control unit 20 may, in particular, recognize a crosstalk of detector 6 and dim or damp this accordingly with respect to the incoming radiant power via LCD array 14.

In the case of a first detector 6 of this type dampable by LCD array 14, second detector 7 may also be omitted since, depending on the application, the dynamic range may be expanded already with one detector 6.

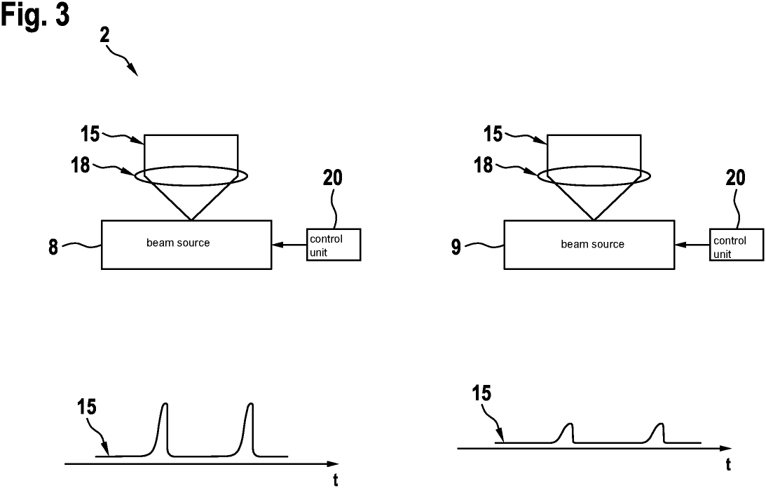

FIG. 3 shows a top view of an emitting unit 2 of LIDAR device 1 including two beam sources 8, 9 with varying radiant powers. Beam sources 8, 9 are designed, for example, as infrared lasers, which vary in power from one another. Such an implementation on the emitting side may take place in combination with the two detectors 6, 7 described or also with one detector 6. In the implementation on the emitting side, it is possible to operate also with two laser sources or, however, also with only one beam source 8. An exemplary vertical line flash in this case involves laser columns. If a laser column is used, it is then possible to reduce the current flow in the beam source designed as a laser column as a function of the detection behavior in saturation and of increased crosstalk. In this way, an adaptive emission power adaptation is achieved. For this purpose, control unit 20 may activate beam source 8 and regulate or control it with respect to the emission power.

In the exemplary embodiment represented, a second beam source 9 designed as a laser column is present in emitting unit 2, which in principle emits generated beams 15 having a lower radiant power. Generated beams 15 are generated in pulsed form and are illustrated, for example, in corresponding time-power diagrams.

In the exemplary embodiment represented, either both beam sources 8, 9 may be activated for illuminating different solid angles of scanning area A and thus for obtaining a bright and dark point cloud or an adaptive adaptation to the surroundings takes place via a rapid switching by control unit 20 between the two beam sources 8, 9. During a rapid switching between beam sources 8, 9, which are intended to illuminate the same solid angle, the same emission optics 18 is preferably utilized by both beam sources 8, 9.

A LIDAR device 1 including an emitting unit 2 from FIG. 3 and an exemplary receiving unit 4 are represented in FIG. 4. Generated beams 15 of first beam source 8 are emitted via a deflection mirror 22 and through a semi-transparent mirror 24 into scanning area A. Alternatively or in addition, generated beams 15 of second beam source 9 are emitted via semi-transparent mirror 24 into scanning area A.

By using deflection mirror 22 as well as one further optical element 24 for merging generated beams 15, it is possible to implement a simple emission path, since generated beams 15 of respective beam sources 8, 9 are not distanced spatially apart from one another.

Optical element 24 or semi-transparent mirror 24 may be designed as a beam splitter or, when using different polarized beam sources 8, 9, as a polarizing beam splitter. If the two beam sources 8, 9 emit generated beams 15 having different wavelengths, semi-transparent mirror 24 may also be designed as a dichroic mirror. As opposed to the simple power adaptation of a beam source 8, the use of two beam sources 8, 9 allows for a faster switching of the emission intensity or radiant power.

The emission power of first beam source 8 and of second beam source 9 may be optionally added for increasing the range of LIDAR device 1 by temporally synchronizing the pulses of generated beams 15.

FIG. 5 schematically shows a top view of a LIDAR device 1 according to one further exemplary embodiment. LIDAR device 1 in this case includes an emitting unit 2, which is situated above or on top of receiving unit 4.

First beam source 8 and second beam source 9 are situated at an angle a next to one another in order to illuminate the different detectors 6, 7 using spatially distanced beams 5, 15. In this arrangement, beams 15 generated by first beam source 8 are guidable as backscattered and/or reflected beams 5 from scanning area A onto second detector 7, and beams 15 generated by second beam source 9 are guidable as backscattered and/or reflected beams 5 from scanning area A onto first detector 8.

Instead of switching, the two beam sources 8, 9 may be activated simultaneously, but illuminate in the process different solid angles of scanning area A. This is achieved in a technically simple manner by an angular offset a between beam sources 8, 9.

Depending on the design of LIDAR device 1, a deflection mirror 22 may be provided, which deflects generated beams 15 onto a deflection unit 28. Deflection unit 28 may be subsequently pivoted, which enables a scanning of scanning area A with generated beams 15. Generated beams 15 of respective beam sources 8, 9 are deflected in two different solid angles of the scanning area.

Detectors 6, 7 shown in FIG. 1 are situated directly below beam sources 8, 9. The receiving path of beams 5 reflected and/or backscattered from scanning area A is designed in parallel to the emission path of generated beams 15 and includes a height offset not represented. This enables the simultaneous recording of a bright and dark point cloud. For the sake of clarity, other optical elements and control unit 20 are not represented.

What is claimed is:

1-15. (canceled)

16. A method for scanning scanning areas using a LIDAR device, comprising the following steps:
generating beams in pulsed form by at least one beam source, and emitting the generated beams into the scanning area;
receiving, by at least one detector, beams reflected and/or backscattered from the scanning area;
wherein the scanning area is scanned by beams having a damped radiant power and/or by beams having an undamped radiant power in order to expand a dynamic range of the LIDAR device.

17. The method as recited in claim 16, wherein the beams having damped radiant power are generated by at least one beam source with reduced power, and/or the beams reflected and/or backscattered from the scanning area are damped by active or passive damping elements with respect to the radiant power to form beams having the damped radiant power.

18. The method as recited in claim 16, wherein the beams having the damped radiant power and the beams having the undamped radiant power are generated and received in temporal succession and/or the beams having the damped radiant power and the beams having the undamped radiant power are emitted into the scanning area and received from the scanning area spatially separated from one another.

19. A LIDAR device for scanning scanning areas, comprising:
an emitting unit including at least one beam source configured to generate and emit beams into the scanning area; and
a receiving unit including at least one detector configured to receive beams reflected and/or backscattered from the scanning area;
wherein a radiant power of the beams reflected and/or backscattered from the scanning area directed at the at least one detector is actively and/or passively damped in an area of the emitting unit and/or in an area of the receiving unit, for expanding a dynamic range of the LIDAR device.

20. The LIDAR device as recited in claim 19, wherein the at least one detector includes at least one first detector and at least one second detector, only measured data of the first detector or only measured data of the second detector or measured data of the first detector and of the second detector combined with one another, being situationally receivable for a further processing by a control unit.

21. The LIDAR device as recited in claim 20, wherein: (i) at least one filter upstream from the first detector is situated in the receiving unit and/or at least one filter downstream from the at least one beam source is situated in the emitting unit, configured to passively damp the radiant power, or (ii) at least one LCD array upstream from the first detector is situated in the receiving unit configured to actively damp the radiant power.

22. The LIDAR device as recited in claim 21, wherein the LCD array is activatable pixelwise by the control unit to damp an entire detection surface or at least a section of the detection surface of the first detector with respect to incoming radiant power.

23. The LIDAR device as recited in claim 19, wherein the radiant power of the beams backscattered and/or reflected from the scanning area directed at the at least one detector is actively dampable indirectly by at least one power-regulated beam source, a radiant power of beams generated by the power-regulated beam source being adjustable by the control unit.

24. The LIDAR device as recited in claim 23, wherein the control unit is configured to decrease the radiant power of the power-regulated beam source in the case of a crosstalk of the at least one detector ascertained based on received measured data of at least one detector of the at least one detector.

25. The LIDAR device as recited in claim 20, wherein the at least one beam source includes a first beam source and a second beam source, the second beam source configured to generate beams having a lower radiant power compared to the generated beams of the first beam source.

26. The LIDAR device as recited in claim 25, wherein the beams generated by the first beam source are guidable as backscattered and/or reflected beams from the scanning area onto the second detector, and the beams generated by the second beam source are guidable as backscattered and/or reflected beams from the scanning area onto the first detector.

27. The LIDAR device as recited in claim 26, wherein the first beam source and the second beam source are situated at an angle next to one another in order to illuminate different detectors.

28. The LIDAR device as recited in claim 25, wherein the beams generated by the first beam source are guidable as backscattered and/or reflected beams from the scanning area onto the first detector and the second detector, and/or the beams generated by the second beam source are guidable as backscattered and/or reflected beams from the scanning area onto the first detector and onto the second detector, wherein the first beam source or the second beam source is adaptively activatable and/or blockable by the control unit.

29. The LIDAR device as recited in claim 28, wherein the generated beams of the first beam source are emittable via a deflection mirror and through a semi-transparent mirror into the scanning area, the generated beams of the second beam source being emittable via the semi-transparent mirror into the scanning area.

30. The LIDAR device as recited in claim 29, wherein the semi-transparent mirror is a polarizing, semi-transparent mirror or a dichroic mirror.

31. The LIDAR device as recited in claim 30, wherein the semi-transparent mirror is a dichroic mirror, and wherein the first beam source emits generated beams, which have a wavelength different from the generated beams of the second beam source.
